(19) United States
(12) Patent Application Publication
(10) Pub. No.: US 2014/0355054 A1
(43) Pub. Date: Dec. 4, 2014

(54) IMAGE FORMING APPARATUS AND CONTINUOUS PRINTING METHOD

(71) Applicant: RISO KAGAKU CORPORATION, Tokyo (JP)

(72) Inventor: Yukihiro OI, Ibaraki (JP)

(73) Assignee: RISO KAGAKU CORPORATION, Tokyo (JP)

(21) Appl. No.: 14/283,497

(22) Filed: May 21, 2014

(30) Foreign Application Priority Data
May 31, 2013 (JP) 2013-115257

(51) Int. Cl. G06K 15/02; G06K 15/00

(52) U.S. Cl. CPC G06K 15/1805; G06K 15/4065
USPC 358/1.15

(57) ABSTRACT

An image forming apparatus prints a print job stored in a memory by a paper supply/feed setup associated with a paper setting of the print job. The apparatus includes a confirmation means for confirming whether or not print jobs with an identical paper setting exist in the print jobs every time when a predetermined condition is satisfied, a changing means for changing, when the print jobs with the identical paper setting exist, a print order of the print jobs stored in the memory so that the print jobs with the identical paper setting are to be printed continuously, and a continuous printing means for printing the print jobs with the identical paper setting continuously by a single paper supply/feed setup without making a temporary wait. According to the apparatus, the print jobs can be printed continuously and efficiently with no temporary wait, and thereby printing productivity can be improved.

### BACKGROUND OF THE INVENTION

1. Technical Field

The present invention relates to an image forming apparatus that prints unfinished print jobs stored in a memory successively by a paper supply/feed setup associated with paper settings of the print jobs, and a successive printing method for printing unfinished print jobs stored in a memory of an image forming apparatus successively by a paper supply/feed setup associated with paper settings of the print jobs.

2. Background Arts

In an image forming apparatus provided with plural paper supply trays (cassettes) for storing print papers, print papers corresponding to a paper setting (e.g. size, orientation, media type) of a print job are picked up from one of the paper supply trays that stores the corresponding print papers, and then supplied to a feed path. Then, images are formed on the supplied print papers by an image forming unit provided in the middle of the feed path, while the supplied papers are fed with an appropriate feed speed and appropriate feed intervals for the supplied print papers.

Therefore, when printing plural print jobs successively, a print process for printing the print jobs is temporarily waited (delayed, paused) at every interval between successive two print jobs. In a case where paper settings of the successive two print jobs are different from each other, paper trays as supply sources of print papers may be changed over and a feed speed and feed intervals may be also changed during the temporary wait. Then, when they are changed, the print process for printing the print is restarted. If a print process is temporarily waited at every interval between successive two print jobs as explained above, the temporary waits may degrade printing productivity to be brought by successive printing of print jobs.

In consideration of the above degradation of printing productivity, it is proposed to restrict temporary waits at every interval between successive two print jobs (for example, see Japanese Patent Application Laid-Open No. 2006-79393). According to the proposal disclosed in the above Patent Application, a temporary wait is not made when a paper setting of a preceding print job is identical to that of a subsequent print job whose preparation is completed during printing of the preceding print job. In such a case, the preceding print job is printed continuously after printing of the preceding print job without the temporary wait.

### SUMMARY OF THE INVENTION

In the above proposal, a continuous printing is made only when a subsequent print job whose paper setting is identical to that of a precedent print job is stored in a memory during printing of the preceding print job. Therefore, improvements by the restrictions of the temporary waits can be brought only under limited conditions.

An object of the present invention is to provide an image forming apparatus that can print, when plural print jobs with an identical paper setting exist, the print jobs with the identical paper setting continuously and efficiently to improve printing productivity.

A first aspect of the present invention provides an image forming apparatus for printing a print job stored in a memory by a paper supply/feed setup associated with a paper setting of the print job, the apparatus comprising: a confirmation means for confirming whether or not print jobs with an identical paper setting exist in the print jobs stored in the memory every time when a predetermined condition is satisfied; a changing means for changing, when the print jobs with the identical paper setting exist, a print order of the print jobs stored in the memory so that the print jobs with the identical paper setting are to be printed continuously; and a continuous printing means for printing the print jobs with the identical paper setting continuously by a single paper supply/feed setup without making a temporary wait.

According to the first aspect, a temporary wait required for changing the paper supply/feed setup is not made while the print jobs with the identical paper setting are printed, and thereby time required for printing can be shortened. In addition, even if a print order of print jobs with an identical paper setting is not successive when the print jobs were stored in the memory, the print order is changed (updated) every time when the predetermined condition is satisfied so that the print jobs with the identical paper setting will be printed continuously. Therefore, the print jobs are printed continuously and efficiently. As a result, time required for printing can be shortened to improve printing productivity.

It is preferable that the image forming apparatus according to the above first aspect further comprises a change requesting means for selecting at least one of the print jobs stored in the memory and requesting a paper setting of the at least one of the print jobs.

According to this configuration, a paper setting of a print job can be changed by the change requesting means after the print job is once stored in the memory. Namely, a paper setting of a print job already stored in the memory can be made identical to another paper setting of another print job(s) already stored in the memory. Therefore, since a paper setting can be changed afterward so as to be made identical to another paper setting after the print jobs are stored, printing productivity can be further improved due to the continuous and efficient printing.

It is preferable that the image forming apparatus according to the above first aspect further comprises a second changing means for changing the print order of the print jobs so that a print job with a thin print paper is assigned an earlier order than an order for an order of a print jobs with a thick print paper.

According to this configuration, it is possible to print as many print jobs as possible until printing is forcibly stopped due to an allowable limit of the number of print papers stacked on a paper ejection tray of the image forming apparatus. Namely, it is possible to finish as many print jobs as possible while printing productivity is improved. Therefore, the print order of the print jobs stored in the memory can be changed in view of the allowable limit of the number of print papers. Therefore, printing productivity can be further improved due to the continuous and efficient printing.

It is preferable that the image forming apparatus according to the above first aspect further comprises a third changing means for changing the print order of the print jobs so that a print job with a large size of a print paper is assigned an earlier order than an order for a print job with a small size of a print paper.

According to this configuration, small-size print papers S are ejected onto large-size print papers S (on a paper ejection tray of the image forming apparatus) and thereby stability of the stacked print papers is improved. Namely, the stacked print papers (especially, the large-size print papers that are held from above by the small-size print papers) are prevented from being misaligned, and prevented from dropping off. Therefore, an undesirable stop of printing due to the misalignment and the drop-off can be prevented. As a result, the print order of the print jobs stored in the memory can be changed in view of the stability of the print papers that were ejected and then stacked to improve printing productivity due to the continuous and efficient printing.

A second aspect of the present invention provides a continuous printing method for printing a print job stored in a memory of an printer by a paper supply/feed setup associated with a paper setting of the print job, the method comprising: confirming whether or not print jobs with an identical paper setting exist in the print jobs stored in the memory every time when a predetermined condition is satisfied; changing, when the print jobs with the identical paper setting exist, a print order of the print jobs stored in the memory so that the print jobs with the identical paper setting are to be printed continuously; and printing the print jobs with the identical paper setting continuously by a single paper supply/feed setup without making a temporary wait.

According to the second aspect, a temporary wait required for changing the paper supply/feed setup is not made while the print jobs with the identical paper setting are printed, and thereby time required for printing can be shortened. In addition, even if a print order of print jobs with an identical paper setting is not successive when the print jobs were stored in the memory, the print order is changed (updated) every time when the predetermined condition is satisfied so that the print jobs with the identical paper setting will be printed continuously. Therefore, the print jobs are printed continuously and efficiently. As a result, time required for printing can be shortened to improve printing productivity.

### BRIEF DESCRIPTION OF THE DRAWINGS

FIG. 1 is a schematic configuration diagram of a network print system including an image forming apparatus (multifunction inkjet printer) according to an embodiment;

FIG. 2 is a diagram for explaining configuration of the image forming apparatus;

FIG. 3 is a screen image that is displayed on a display of the image forming apparatus and shows a list of stored print jobs that are not finished;

FIG. 4 is a flowchart of a print order update process executed by a control unit of the image forming apparatus; and

FIG. 5 is a flowchart of a print job print process executed by the control unit.

### DESCRIPTION OF THE EMBODIMENTS

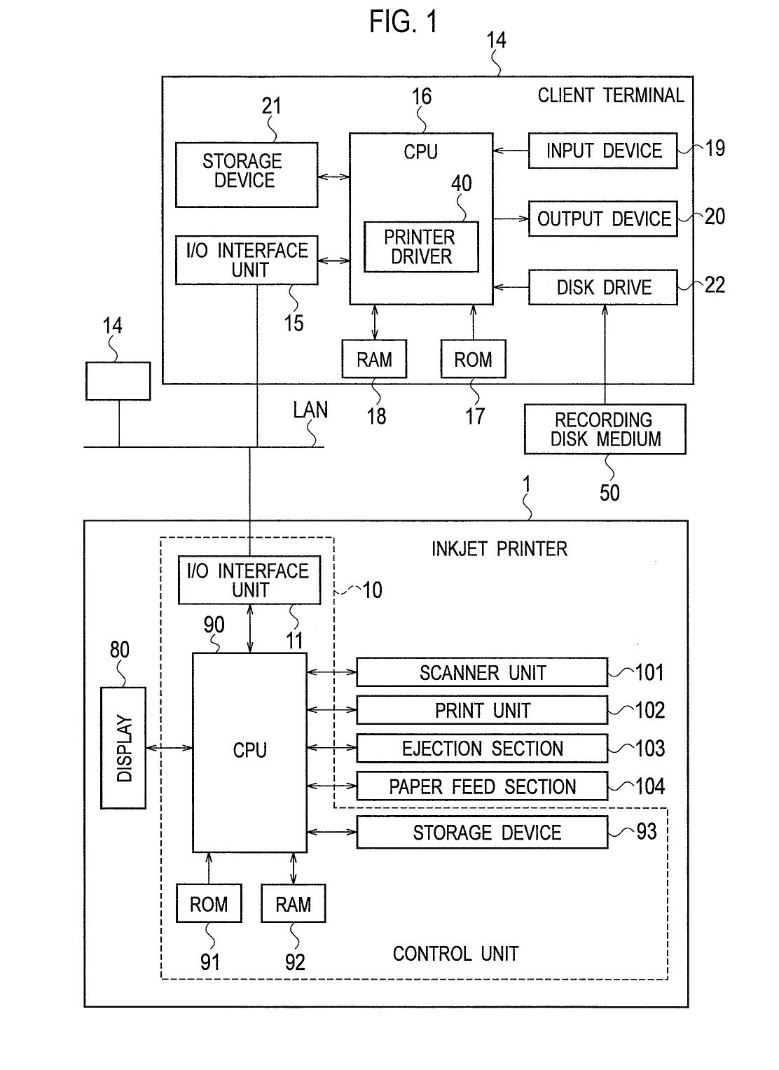

Hereinafter, an image forming apparatus according to an embodiment will be explained with reference to the drawings. Note that the image forming apparatus according to the present embodiment is a multifunction color inkjet line printer 1 in a network print system shown in FIG. 1.

As shown in FIG. 1, the network print system includes the inkjet printer 1 and client terminals 14 that are connected by a local area network (LAN) with each other.

Each of the client terminals 14 is built up with a PC (personal computer) or the like. The client terminal 14 includes a CPU 16 for executing various processes based on control programs stored in a ROM 17. In addition, the CPU 16 is connected with a RAM 18 functioning as a working area, an input device 19 built up with a keyboard, a mouse and so on, an output device 20 built up with an LCD or the like, a storage device 21 such as a HDD, and a disk drive 22.

In the storage device 21, prepared are a storage area of application programs for generating original data including print images such as texts and images, a storage area of a printer driver of the inkjet printer 1, and a storage area of other various application programs. In addition, in the storage device 21, also prepared is a database area for storing the original data generated by the application programs and print data that are print image data converted from the original data based on print setting information.

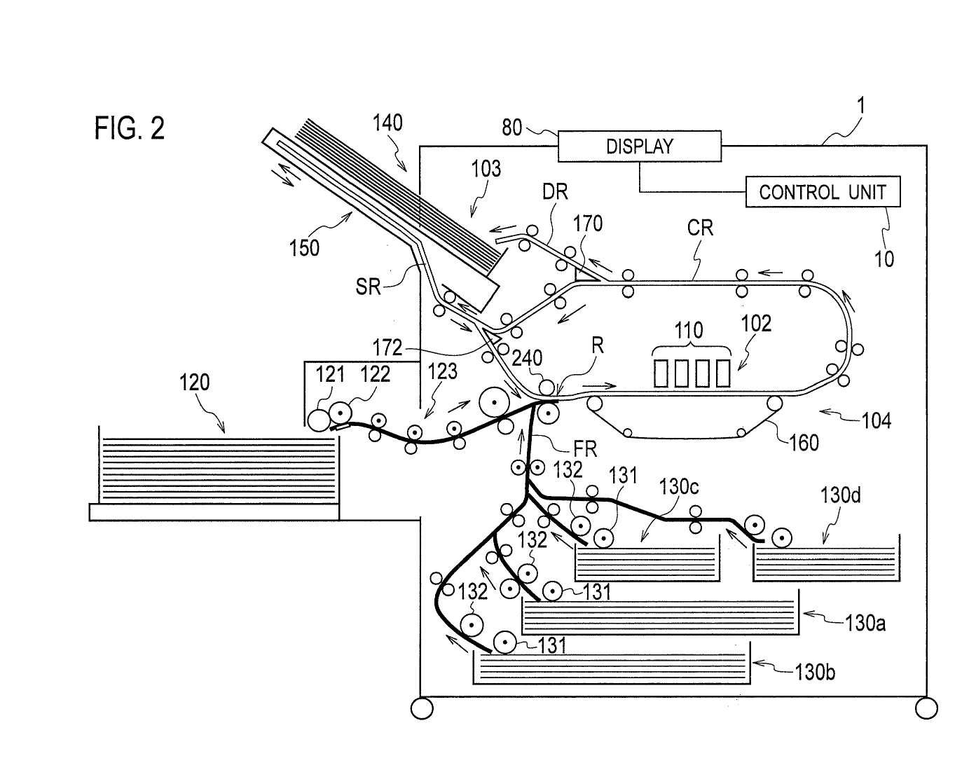

Here, the print setting information is information that is generally required for printing and includes a size of the original data, resolution information, and a paper setting of print papers S (see FIG. 2) such as size [A4, A3, B4, B5 or the like], orientation [portrait, landscape], media type [e.g. thick paper with large basis weight, thin paper with small basis weight or the like] and so on. In addition, the print setting information also includes information of a print mode such as variable printing and a finishing process such as enveloping process.

The CPU 16 is an arithmetic device built up with a processor, a memory and other peripheral devices, and runs an application program stored in the storage device 21 according to a run command input through the input device 19. In addition, the CPU 16 generates original data on the application program according to user's instructions input through the input device 19. The generated original data is displayed on the output device 20, and stored in the database area of the storage device 21 when a save command is input through the input device 19 by the user.

The original data stored in the database area of the storage device 21 is retrieved when the application program is run and a retrieve command is input through the input device 19. The print images of the retrieved original data can be displayed on the output device 20, and can be modified on the application program as a new original data.

In addition, the CPU 16 sets up a printer driver 40 virtually on the CPU 16 by executing a printer driver program on the CPU 16 when a print command for the original data generated by the application program is input. Then, the inkjet printer 1 is controlled to output the print job by the printer driver 40.

The printer driver 40 is a data conversion program executed on the client terminals 14 for controlling the inkjet printer 1 connected with the client terminals 14. The printer driver 40 retrieves original data including the print images generated by the application program, and then generates print data having a bitmap data format based on given print setting information. Then, it outputs the generated print data and the print job including the above print setting information from an I/O interface unit 15 to an I/O interface unit 11 of the control unit 10.

The printer driver program and various application programs for executing the above-explained processes by the CPU 16 can be installed to (stored in) the storage device 21 by reading them out from a recording disk medium 50 such as an optical disk by using a disk drive 22 of the client terminal 14.

The inkjet printer (image forming apparatus) 1 includes plural inkjet heads on each of which many nozzles are formed, and black or color ink droplets are ejected from the inkjet heads to print images line by line on a print paper S fed by a feed belt 160 (see FIG. 2) so as to partially overlap the images. The images overlapped line by line forms a page image as a whole.

The inkjet printer 1 includes a scanner unit 101 that scans an original document as images and then outputs them as image signals when the printer 1 is used as a copy machine, a print unit 102 that prints (records) the images on recording papers (single side or double sides) based on the image signals output from the scanner unit 101, and the control unit 10 for an overall control of the printer 1. The recording papers used for printing images in the print unit 102 are fed to an ejection section 103 through the print unit 102 by a paper feed section 104. Note that the print unit 102 also prints images based on print data from the client terminals 14 when the printer 1 is used as a printer.

As shown in FIG. 2, the inkjet printer 1 in the present embodiment includes a looped feed path. The feed path is composed of supply paths FR for supplying print papers S, a normal path CR extending from an end of the supply paths FR to an ejection path DR via a head unit 110, and a switchback path RR branched from the normal path CR.

Along the supply paths FR, print papers S are supplied from a paper supply side tray 120 or paper supply trays (cassettes) 130 (130a to 130d) on each of which the print paper S are stored in a stacked manner. The paper supply side tray 120 is disposed outside from a side face of a housing of the printer 1, and the paper supply trays 130 are disposed within the housing.

Different type of print papers S (size [A4, A3, B4, B5 and so on], orientation [portrait, landscape], media type [e.g. thick paper with large basis weight, thin paper with small basis weight, and so on]) can be set in the paper supply trays 130, respectively. The paper supply side tray 120 is a so-called bypass tray, and various types of print papers S that are able to be fed along the above-mentioned feed paths can be set on the paper supply side tray 120.

The paper supply side tray 120 is provided with a paper supply mechanism. The paper supply mechanism includes a paper supply roller 121 for picking up a print paper S paper by paper from print papers S stacked on the paper supply side tray 120, a feed forward roller 122 for feeding forward the print paper S picked-up by the paper supply roller 121, and intermediate feed rollers 123 for sequentially feeding the print paper S fed from the feed forward roller 122. The intermediate feed rollers 123 feed the print paper S to a pair of registration rollers 240 at a registration position R.

Also, the paper supply trays 130 are provided with a paper supply mechanism. The paper supply mechanism includes paper supply rollers 131 for picking up a print paper S paper by paper from print papers S stacked on the paper supply trays 130, and feed forward rollers 132 for feeding forward the print paper S picked-up by the paper supply rollers 131. The paper supply rollers 131 feed the print paper S to the pair of registration rollers 240 at the registration position R.

The print papers S on the paper supply side tray 120 and the paper supply trays 130 are fed along the supply paths FR by the paper supply rollers 121 and 131, the feed forward rollers 122 and 132, and the intermediate feed rollers 123 with an appropriate feed speed and appropriate feed intervals for a paper type (size, orientation and media type) of the print papers S, and then led to the registration position R that is a reference position for each leading edge of the print papers S.

On a downstream side from the registration position R, an image forming unit constituting the print unit 102 is provided. The head unit 110 including the inkjet heads is provided in the image forming unit. Images are formed on a print sheet S by ink droplets ejected from the inkjet heads while the print sheet S is fed by the feed belt 160 facing the inkjet heads with a feed speed regulated according a printing condition.

The printed print paper S is further fed along the normal path CR by a drive mechanism such as rollers. As an ejection mechanism, the ejection path DR is branched-from and connected-with the normal path CR and a paper ejection slot 140 for ejecting printed print papers S is formed at an end of the ejection path DR.

In a case of single-side printing, print papers S are led to the paper ejection slot 140 through the ejection path DR by the drive mechanism such as rollers to be ejected paper by paper, and then stacked on an paper ejection tray 150 provided as a receiving tray for the paper ejection slot 140 with its printed side faced down. The drive mechanism of the ejection path DR constitutes the ejection section 103.

On the other hand, in a case of duplex printing, a print paper S whose one side is printed is not led to the ejection path DR, but fed to the switchback path SR. A switching mechanism 170 is disposed at a branch point of the ejection path DR and the switchback path SR. The switching mechanism 170 switches over the feed paths for duplex printing. The print paper S prevented from being led to the ejection path DR by the switching mechanism 170 is fed to the switchback path SR.

On the switchback path SR, the print paper S is transferred from the normal path CR, and then turned over by being switch-backed by use of a space in the paper ejection tray 150. Subsequently, the print paper S is returned to the normal path CR by the drive mechanism such as rollers through a switching mechanism 172. The print paper S is supplied to the normal path CR again through the registration position R, and then another side of the print paper S is printed by the print unit 102 according to similar processes to those for printing the one side of the print paper S. The print paper S whose other side is printed is let to the paper ejection slot 140 through the ejection path DR, and then ejected onto the paper ejection tray 150 provided as a receiving tray of the paper ejection slot 140. Ejected print papers S are stacked on the paper ejection tray 150.

In the above-explained inkjet printer 1 in the present embodiment, the paper feed section 104 is configured of the above-mentioned paper supply mechanisms of the paper supply side tray 120 and the paper supply trays 130, the pair of registration rollers 240 at the registration position R, the feed belt 160, and drive mechanisms of the normal path CR and the switchback path SR.

In a case where plural print jobs for different types of print papers S (size, orientation, media type and so on) are printed (executed) successively in the above-explained inkjet printer 1, it is needed to change over paper supply/feed setups [the paper supply (side) trays 120 and 130 as supply sources of print papers S, paper supply paths to the registration position R, feed speed and feed intervals of print papers S on the feed paths, and so on]. In such a case, a print cycle that is a series of printing operations in the inkjet printer 1 is waited (delayed) temporarily at a transition between every two successive print jobs. The print cycle is restarted when the paper supply/feed setups for print papers S are changed over.

Operations of the scanner unit 101, the print unit 102, the ejection section 103, the paper feed section 104 in the inkjet printer 1, such as starting, waiting and restarting of a print cycle, are controlled by the control unit 10.

As shown in FIG. 1, the I/O interface unit 11 of the control unit 10 is connected with the I/O interface units 15 of the client terminals 14 via the LAN (only one of the client terminals are shown in detail in FIG. 1 as a representative of them). The control unit 10 receives print jobs including print images from the client terminals 14. The control unit 10 generates raster data of the print images from print data in the received print job to expand them into bitmap images. When print data in the received print job are vector data, the control unit 10 rasterises the vector data into raster data by a RIP conversion to get bitmap images. Note that there may be a case where the printer driver of the client terminal 14 generates raster data, and then sends them to the inkjet printer 1 via the LAN. The inkjet printer 1 prints print images (bitmap images in the raster data) on a print paper S at the print unit 102 based on print settings in the print job.

In addition, a display 80 is connected with the control unit 10. The display 80 is disposed at an upper portion of the inkjet printer 1. The display 80 can be used as an operational input panel into which a user can input various commands. For example, when a user copies an original that is set at the scanner unit 101, the user can input a copy setting (the number of copies, page scaling and so on) into the display 80.

The control unit 10 includes a CPU 90. The CPU 90 controls, based on programs and setting information that are stored in a ROM 91, operations of the scanner unit 101, the print unit 102, the ejection section 103 and the paper feed section 104 according to settings input from the display 80.

Note that the control unit 10 also includes a RAM 92, and the RAM 92 stores, as needed, print jobs input to the control unit 10 from the client terminals 14 and various settings, such as the number of copies, input from the display 80. In addition, a frame memory area is prepared in the RAM 92. In the frame memory area, the raster data of the print images generated by the CPU 90 from the print job input to the control unit 10 from the client terminal 14 are stored temporarily until the raster data are output to the print unit 102.

In addition, the control unit 10 further includes a storage device (a memory) 92, and the storage device 93 is connected with the CPU 90. In the storage device 93, prepared are an area for storing unfinished print jobs sent from the RAM 92, and an area for storing finished print jobs selectively.

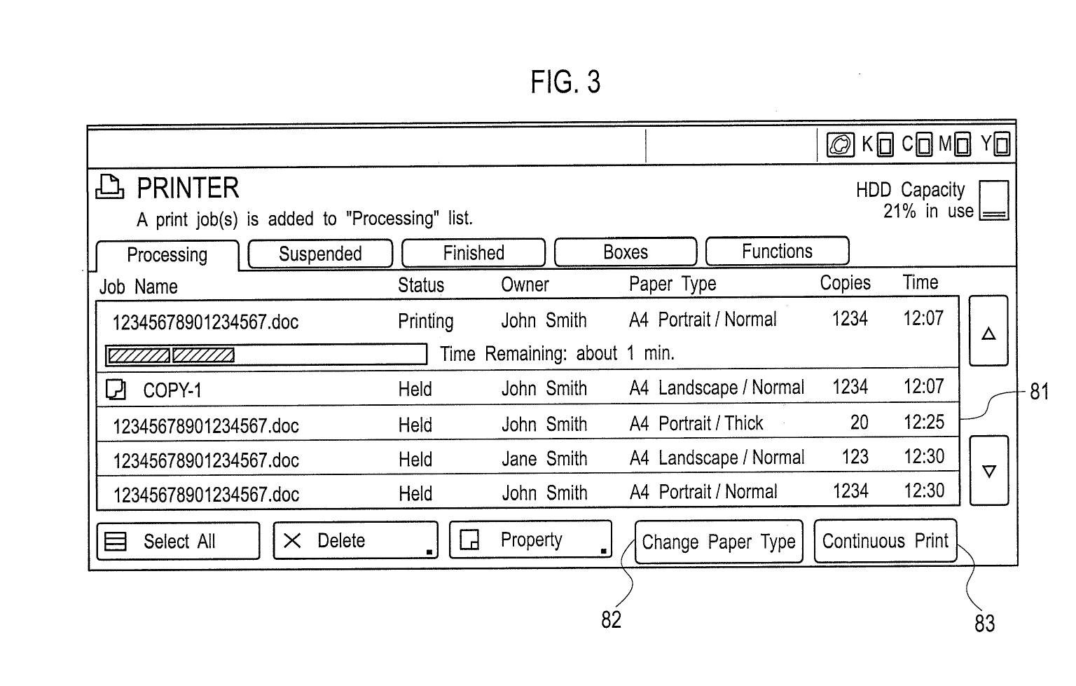

FIG. 3 is a screen image that is displayed on the display 80. A “Processing” tab includes a list 81 of unfinished print jobs stored in the storage device 93. The list 81 includes print jobs input from the client terminals 14, print jobs for copying of an original document scanned by the scanner unit 101, print jobs for reprinting (box-printing) of once-printed print jobs stored in the storage device 93, and so on.

In the list 81, the print jobs are listed up in an order of their generation (their accumulation in the storage device 93) by default. The listed-up print jobs will be processed sequentially in the order shown in the list 81. Note that types of print papers S (size, orientation, media type, and so on) are also shown in the list 81 based on paper setting information of the print jobs.

The display 80 is provided with a touchscreen, and a target print job(s) in the list 81 can be selected by being touched on the display 80. When an unfinished print job in the list 81 is selected and then a “Change Paper Type” button 82 is touched, a paper type (paper setting) of print papers S (size, orientation, media type, and so on) for the selected print job can be changed in another screen image (not shown) displayed on the display 80. Namely, in the present embodiment, the “Change Paper Type” button 82 corresponds to a change requesting means in Claims.

In addition, when a “Continuous Print” button 83 is touched, an order of the print jobs listed-up in the list 81 (i.e. print order of the print jobs) is changed so that print jobs whose paper types (paper settings) are identical to each other will be printed continuously.

Note that, when a request for changing a paper type of any print job in the list 81 in this “Continuous Print” mode is made by the above-explained operation of the “Change Paper Type” button 82, it is possible to update the order automatically according to the changed paper type without a touch operation of the “Continuous Print” button 83.

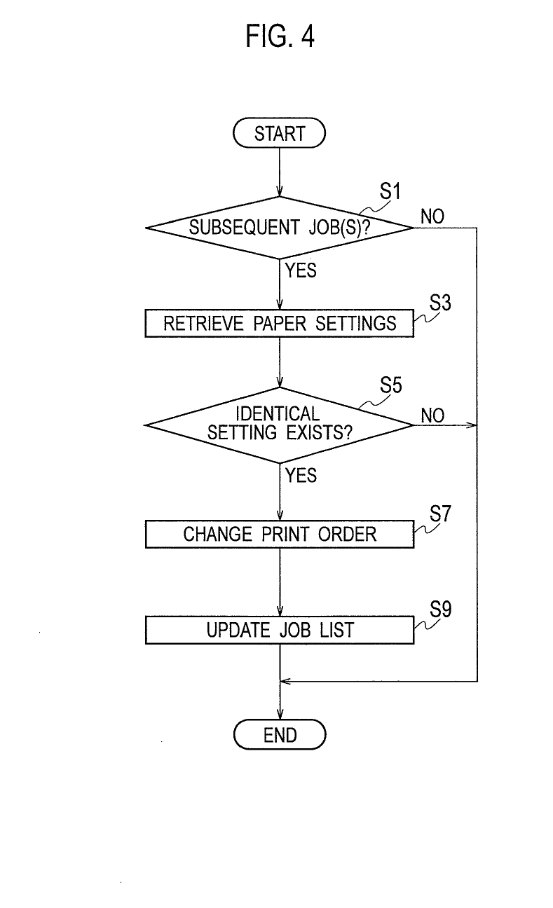

Next, a print order update process will be explained with reference to a flowchart shown in FIG. 4. The print order update process is executed by the CPU 90 of the control unit 10 according to a program stored in the ROM 91. In the present embodiment, the print order update process shown by the flowchart is executed every time when a request for changing print jobs is made by a touch operation of the “Change Paper Type” button 82 or the “Continuous Print” button 83.

First, the CPU 90 determines whether or not one or more print jobs subsequent to a currently-printed print job are stored in the storage device 93 (step S1). If no subsequent print job is stored (NO in step S1), the process flow is ended. On the other hand, if one or more subsequent print jobs are stored (YES in step S1), the CPU 90 retrieves paper settings of all print jobs (step S3). Based on the paper settings (paper type/i.e. a size, an orientation and a media type of print papers S), the CPU 90 confirms whether or not print jobs whose paper types are identical to each other exist among the print jobs including the currently-printed print job (step S5).

If print jobs whose paper types are identical are not found (NO in step S5), the process flow is ended. On the other hand, if print jobs whose paper types are identical are found (YES in step S5), the print order of print jobs are changed so that the found print jobs whose paper types are identical will be printed continuously without a temporary wait (step S7). And then, the list 81 is updated based on the changed print order of print jobs (step S9). After step S9, the process flow is ended.

Note that, in the print order change in step S7, if two or more groups of print jobs whose paper types are identical are found, a print job(s) with a thin print paper S is given priority over (located higher up in the list 81 than/assigned an earlier order than an order for) a print job(s) with a thick print paper S. In addition, among the print jobs with identical thickness of a print paper S, a print job(s) with the small number of copies is given priority over (located higher up in the list 81 than/assigned an earlier order than an order for) a print job(s) with the large number of copies. Further, among the print jobs with the same number of copies, a print job(s) with a large size of a print paper S is given priority over (located higher up in the list 81 than/assigned an earlier order than an order for) a print job(s) with a small size of a print paper S.

A Table 1 shown below is an example of the list 81 before the print order update process, and a Table 2 shown below is the updated list 81 after the print order update process. Here, the print order update process is made by touch operations of the “Change Paper Type” button 82 for changing “Media Type” of Job ID 1 from “Normal” to “Thin”, and that of Job ID 2 from “Thick” to “Normal”.

TABLE 1

| Job ID | No. of Copies | Paper Size | Media Type | Changed |
|---|---|---|---|---|
| 1 | 3 | A4 Landscape | Normal | to Thin |
| 2 | 100 | A4 Portrait | Thick | to Normal |
| 3 | 1 | A3 | Normal | |
| 4 | 10 | A4 Landscape | Thin | |
| 5 | 50 | A4 Portrait | Normal | |
| 6 | 5 | A3 | Normal | |

TABLE 2

| Job ID | No. of Copies | Paper Size | Media Type |
|---|---|---|---|
| 1 | 3 | A4 Landscape | Thin |
| 4 | 10 | A4 Landscape | Thin |
| 3 | 1 | A3 | Normal |
| 6 | 5 | A3 | Normal |
| 2 | 100 | A4 Portrait | Normal |
| 5 | 50 | A4 Portrait | Normal |

Due to the print order update process by the touch operation of the “Change Paper Type” button 82 (and a touch operation of the “Continuous Print” button 83), the print order of the print jobs in the storage device 93 is changed so that print jobs with identical paper types will be printed continuously.

Specifically, as shown in Table 2, the orders of Job IDs 1 and 4 with the thinnest paper type (A4 landscape, Thin Paper) are changed to the first and the second. In addition, the orders of Job IDs 3 and 6 with the largest paper size (A3, Normal) and the relatively small number of copies (1, 5) are changed to the third and the fourth. Further, the orders of Job Ids 2 and 5 with the remaining paper type (A4 Portrait, Normal) and the large number of copies (100, 50) are changed to the fifth and the sixth.

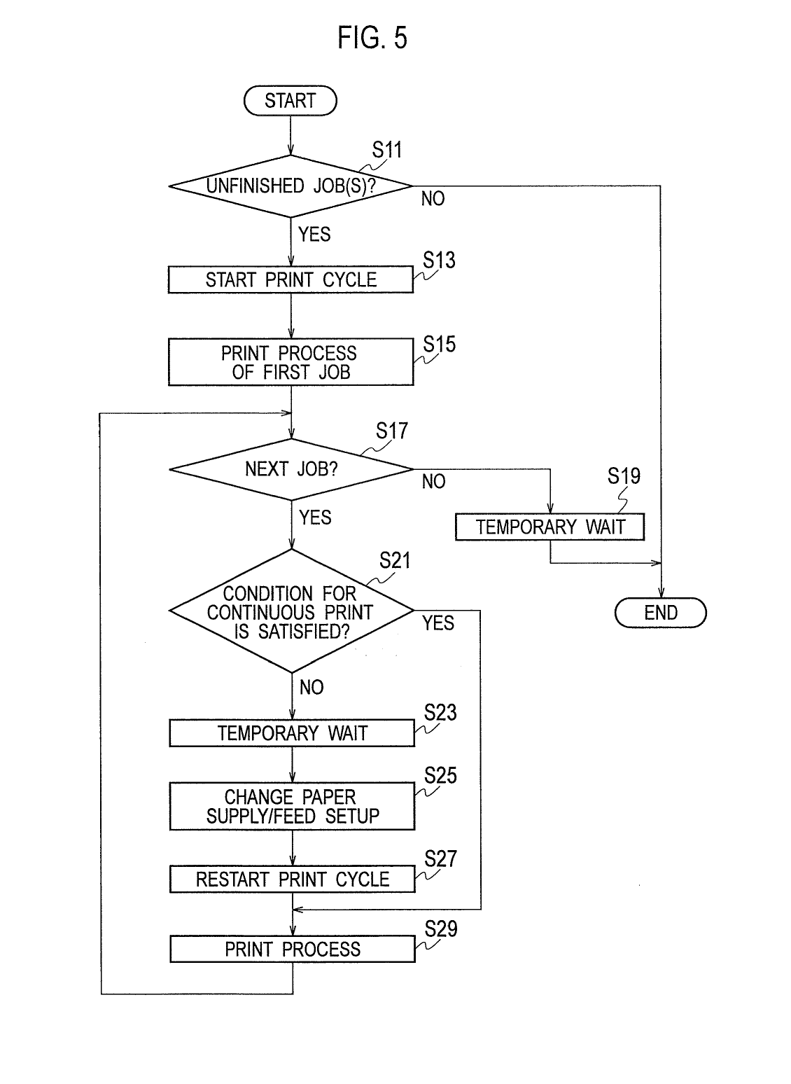

Next, a print job print process will be explained with reference to a flowchart shown in FIG. 5. The print job print process is periodically executed by the CPU 90 of the control unit 10 according to a program stored in the ROM 91.

First, the CPU 90 determines whether or not one or more unfinished print jobs are stored in the storage device 93 (step S11). If no unfinished print job is stored (NO in step S11), the process flow is ended. On the other hand, if one or more unfinished print jobs are stored (YES in step S11), the CPU 90 starts a print cycle by putting the print unit 102, the ejection section 103 and the paper feed section 104 (step S13) into an activated state. When the print unit 102, the ejection section 103 and the paper feed section 104 are put into the idle state, the first print job is printed (step S15).

Subsequently, the CPU 90 determines whether or not an unfinished print job next to the currently-printed print job remains in the storage device 93 (step S17). If the no print job remains (NO in step S17), the CPU 90 makes the print cycle waited (delayed) temporarily by deactivating the print unit 102, the ejection section 103 and the paper feed section 104 (step S19). After the deactivation, a process flow is ended.

If the one or more print job remains (YES in step S17), the CPU 90 determines whether or not the next print job satisfies a condition for a continuous print (step S21). Here, the continuous print condition will be satisfied when a paper setting of the next print job is identical to that of a currently-printed print job (i.e. the first print job printed in the step S15 or a print job printed in an after-explained step S29).

If the continuous print condition is not satisfied (NO in step S21), the CPU 90 makes the print cycle waited (delayed) temporarily by deactivating the print unit 102, the ejection section 103 and the paper feed section 104 (step S23). While the print cycle is temporarily waited, a paper supply/feed setup is changed (optimized) based on a paper setting of the unfinished print job to be printed next (step S25). After the paper supply/feed setup is changed over, the print cycle is restarted (step S27). After the print cycle is restarted, the next print job is printed by the changed paper supply/feed setup (step S29). When printing of the next print job is started, the process flow is returned to the step S17.

On the other hand, if the continuous print condition is satisfied (YES in step S21), the next unfinished print job is printed without a temporary wait of the print cycle [by an unchanged paper supply/feed setup] (step S29). When printing of the next print job is started, the process flow is returned to the step S17.

It is obvious from the above explanations that, in the present embodiment, the step S5 in the flowchart shown in FIG. 4 corresponds to a process associated with a confirmation means in Claims. Similarly, it is obvious from the above explanations that, in the present embodiment, the steps S7 and S9 correspond to a process associated with a changing means in Claims. It is obvious from the above explanations that, in the present embodiment, the steps S7 and S9 also correspond to a process associated with a third changing means in Claims. In addition, it is obvious from the above explanations that, in the present embodiment, the affirmative step S21 and the step S29 after the affirmative step S21 correspond to a process associated with a continuous printing means in Claims. Namely, in the present embodiment, the control unit 10 functions as the confirmation means, the changing means, the third changing means, and the continuous printing means in Claims.

In the inkjet printer 1 (image forming apparatus) in the present embodiment, when a request for changing a print order of unfinished print jobs stored in the storage device 93 by an touch operation of the “Change Paper Type” button 82 or the “Continuous Print” button 83 shown in FIG. 3, the print order of the unfinished print jobs is changed so that print jobs with an identical paper setting in the unfinished print jobs will be printed continuously. Then, the print jobs with the identical paper setting are printed continuously by a single paper supply/feed setup with no temporary wait of its print cycle. Since no temporary wait is made while the print jobs with the identical paper setting are printed, time required for printing can be shortened.

In addition, even if a storing order of print jobs with an identical paper setting is not successive when the print jobs were stored in the storage device 93, a print order is changed so that print jobs with an identical paper setting will be printed continuously every time when a request for changing the print order of unfinished print jobs by an touch operation of the “Change Paper Type” button 82 or the “Continuous Print” button 83. Therefore, even if a print order of print jobs with an identical paper setting is not made successive due to a storing order of the print jobs, the print order of print jobs with an identical paper setting can be changed later to shorten the time required for printing. As a result, when plural print jobs with an identical paper setting exist, printing productivity can be improved by printing the print jobs continuously and efficiently with no temporal wait.

Note that an execution timing of the print order update process shown by the flowchart in FIG. 4 is not limited to an execution timing in the present embodiment, i.e. a timing of an touch operation of the “Change Paper Type” button 82 or the “Continuous Print” button 83. For example, the print order update process may be executed periodically with predetermined time intervals. Or, the print order update process may be executed every time when control unit 10 receives new print jobs from the client terminal(s) 14.

In addition, when printing print jobs that were printed at least once and then stored (held) in the storage device 93, the control unit 10 doesn't receive the print job fro the client terminal(s) 14 when the print jobs are listed up as new (unfinished) print jobs in the storage device 93. Therefore, the print order update process may be executed every time when new print jobs are stored or listed up in the storage device 93, and/or every time when a current print process is finished.

Further, the print order update process may be executed every time when one or more unfinished print jobs stored in the storage device 93 are deleted. In doing so, when print jobs with an identical paper setting are deleted, a print order of remained unfinished print jobs can be revised so that the remained unfinished print jobs will be printed in an adequate order.

In cases where the print order update process is executed regardless of a request for changing a print order of unfinished print jobs stored in the storage device 93 by an touch operation of the “Change Paper Type” button 82 or the “Continuous Print” button 83, the “Continuous Print” button 83 may be omitted from the screen image shown in FIG. 3 (the “Continuous Print” button 83 is not displayed on the display 80). In these cases, a print order of unfinished print jobs with an identical paper setting is made successive with no operation of the “Continuous Print” button 83 to print the unfinished print jobs with an identical paper setting continuously.

Although a paper type of print papers S for a print job can be changed by a touch operation of the “Change Paper Type” button 82 shown in FIG. 3 in the present embodiment, this configuration may not be adopted in the inkjet printer 1. However, if a paper type of print papers S for a print job can be changed by a touch operation of the “Change Paper Type” button 82 as in the present embodiment, a paper type of print papers S for a print job can be changed after the print job is once stored in the storage device 93. Namely, a paper type of print papers S for a print job that is already stored in the storage device 93 can be made identical to another paper type of print papers S for another print job(s) that is already stored in the storage device. Therefore, since a paper setting (paper type) can be changed afterward so as to be made identical to another paper setting (paper type) after the print jobs are stored, printing productivity can be further improved due to the continuous printing.

In the present embodiment, print jobs with a thin print paper S are given priority over print jobs with a thick print paper S in step S7 of the print order update process shown by the flowchart in FIG. 4 when two or more groups of print jobs whose paper types are identical are found. Similarly, print jobs with the small number of copies are given priority over print jobs with the large number of copies among print jobs with identical thickness of a print paper S, and print jobs with a large size of a print paper S are given priority over print jobs with a small size of print paper S among print jobs with the same number of copies. These configurations may be adopted in any combination of the three, i.e. only one, only two or none of the three may be adopted in the inkjet printer 1.

However, when a print job with a large size of a print paper S is given priority over a print job with a small size of a print paper S with respect to print jobs with the same number of copies, the small-size print paper S are ejected onto the large-size print paper S stacked on the paper ejection tray 150 and thereby stability of the print papers S stacked on the paper ejection tray 150 is improved. Namely, the stacked print papers S (especially, the large-size print papers S that are held from above by the small-size print papers S) are prevented from being misaligned, and prevented from dropping off. Therefore, an undesirable stop of printing due to the misalignment and the drop-off can be prevented. As a result, the print order of print jobs can be determined in view of the stability of print papers S ejected and then stacked on the paper ejection tray 150 in order to improve printing productivity.

Note that print jobs with a thin print paper S may be given priority over print jobs with a thick print paper S as in the present embodiment only when the total number of print papers S to be printed out is expected to excess over the maximum allowable number of copies to be stacked on the paper ejection tray 150. According to this, it is possible to print as many print papers S as possible until a print cycle is forcibly stopped due to an allowable limit of the number of print papers S stacked on the paper ejection tray 150. Namely, it is possible to finish as many print jobs as possible while printing productivity is improved. Note that, in this case, the step S7 in the flowchart shown in FIG. 4 corresponds to a process associated with a second changing means in Claims.

Further, although the image forming apparatus is the inkjet printer 1 in the above-explained present embodiment, the image forming apparatus is not limited to an inkjet printer. For example, the image forming apparatus may be another type of printer, such as an electrophotographic printer and a mimeographic printer.

The present invention is not limited to the above-mentioned embodiment, and it is possible to embody the present invention by modifying its components in a range that does not depart from the scope thereof Further, it is possible to form various kinds of inventions by appropriately combining a plurality of components disclosed in the above-mentioned embodiment. For example, it may be possible to omit several components from all of the components shown in the above-mentioned embodiment.

The present application claims the benefit of a priority under 35 U.S.C. §119 to Japanese Patent Application No. 2013-115257, filed on May 31, 2013, the entire content of which is incorporated herein by reference.

1. An image forming apparatus for printing a print job stored in a memory by a paper supply/feed setup associated with a paper setting of the print job, the apparatus comprising:
confirmer that confirms whether or not print jobs with an identical paper setting are present in the print jobs stored in the memory every time that a predetermined condition is satisfied;
a changer that, when the print jobs with the identical paper setting are present, changes a print order of the print jobs stored in the memory so that the print jobs with the identical paper setting are printed continuously; and
a continuous printer that prints the print jobs with the identical paper setting continuously by a single paper supply/feed setup without making a temporary wait.

2. The image forming apparatus according to claim 1, further comprising
a change requester that selects at least one of the print jobs stored in the memory and request a paper setting of the at least one of the print jobs.

3. The image forming apparatus according to claim 1, further comprising
a second changer that changes the print order of the print jobs so that a print job with a thin print paper is assigned an earlier order than an order for an order of a print jobs with a thick print paper.

4. The image forming apparatus according to claim 1, further comprising
a third changer that changes the print order of the print jobs so that a print job with a large size of a print paper is assigned an earlier order than an order for a print job with a small size of a print paper.

5. A continuous printing method for printing a print job stored in a memory of an printer by a paper supply/feed setup associated with a paper setting of the print job, the method comprising:
confirming whether or not print jobs with an identical paper setting are present in the print jobs stored in the memory every time that a predetermined condition is satisfied;
changing, when the print jobs with the identical paper setting are present, a print order of the print jobs stored in the memory so that the print jobs with the identical paper setting are printed continuously; and
printing the print jobs with the identical paper setting continuously by a single paper supply/feed setup without making a temporary wait.
